(19) United States
(12) Patent Application Publication
(10) Pub. No.: US 2024/0343848 A1
(43) Pub. Date: Oct. 17, 2024

(54) FREE-RADICALLY POLYMERIZABLE COMPOSITION, METHOD OF POLYMERIZING THE SAME, AND POLYMERIZED COMPOSITION

(71) Applicant: 3M INNOVATIVE PROPERTIES COMPANY, St. Paul, MN (US)

(72) Inventors: Erik M. Townsend, South Saint Paul, MN (US); William H. Moser, Edina, MN (US); Amanda K. Leone, Saint Paul, MN (US); Wayne S. Mahoney, Saint Paul, MN (US)

(21) Appl. No.: 18/294,948

(22) PCT Filed: Aug. 18, 2022
(86) PCT No.: PCT/IB2022/057757

§ 371 Date: Feb. 2, 2024

Related U.S. Application Data
(60) Provisional application No. 63/239,758, filed on Sep. 1, 2021.

(51) Int. Cl. C08F 220/18; C08F 2/50; C08F 4/40

(52) U.S. Cl. CPC C08F 220/18; C08F 2/50; C08F 4/40

(57) ABSTRACT

A free-radically polymerizable composition comprises at least one free-radically polymerizable compound, at least one transition metal acetylacetonate coordination complex having a neutral charge, and a photolabile reducing agent represented by the formula I R¹, R², and R³ a independently H or a C₁-C₁₈ hydrocarbyl group, and R⁴ is H or methyl. A method of polymerizing the free-radically polymerizable composition to provide an at least partially polymerized composition is also disclosed.

### TECHNICAL FIELD

The present disclosure broadly relates to free-radically polymerizable compositions, methods of making them, and polymerized products producible therefrom.

### BACKGROUND

Redox free-radical polymerization is a prominent and industrially relevant chemical technique for rapid generation of polymers at ambient conditions. Typical known redox radical polymerization systems include a free-radically polymerizable monomer, an oxidizing agent, and a reducing agent. The oxidizing and reducing agents are selected to react with one another to generate free-radical species, which in turn can initiate a radical-mediated reaction of monomers to form polymer. The oxidizing and reducing agents are most often stored on separate sides of a 2-part formulation, giving users the ability to mix the parts and produce polymer when desired.

Industrial redox radical polymerization systems often comprise a (hydro)peroxide and an amine as the oxidizing and reducing agent, respectively. While amine-peroxide initiators are robust and versatile, they do possess significant drawbacks that can limit their use. For example, many of the preferred tertiary and/or aromatic amines are relatively toxic, and peroxides as a class are plagued by shelf-life, and explosion hazard concerns. Another limitation of conventional redox polymerization systems is that their reactivity can be difficult to control. As mentioned above, the oxidizing and reducing agents must be stored separately to preserve shelf-life, and the only way for a user to initiate polymerization is to mix them together.

In contrast, free-radical photopolymerization systems allow for precise control of reactivity with application of light. The need for application of light to cause polymerization can be an advantage in some cases, but a constraint in others (i.e., when polymerization must take place in areas inaccessible to light).

### SUMMARY

It would be desirable to provide free-radically polymerizable compositions with the robustness of redox polymerizable systems and the advantages of photopolymerizable compositions. Advantageously, the present disclosure provides free-radically polymerizable compositions that need no amines, nor added oxidizers such as peroxides. The free-radically polymerizable compositions comprise one-part compositions that can be photoactivated (e.g., activated on-demand) and have better shelf-life characteristics than many prior art formulations.

Accordingly, in one aspect, the present disclosure provides a free-radically polymerizable composition comprising:
at least one free-radically polymerizable compound;
at least one transition metal acetylacetonate coordination complex having a neutral charge; and
a photolabile reducing agent represented by the formula

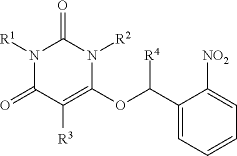

wherein R¹, R², and R³ are independently H or a C₁-C₁₈ hydrocarbyl group, and R⁴ is H or methyl.

In another aspect, the present disclosure provides a method of polymerizing a free-radically polymerizable composition, the method comprising exposing a free-radically polymerizable composition according to the present disclosure to actinic radiation effective to initiate free-radical polymerization and provide an at least partially polymerized composition.

In yet another aspect, the present disclosure provides an at least partially polymerized composition made according to the above method.

As used herein, the term “hydrocarbyl” refers to a monovalent group derived from a hydrocarbon. Examples include methyl, phenyl, and methylcyclohexyl.

As used herein, the term “transition metal” refers to elements in groups 3 through 11 of the Periodic Table of the Elements, exclusive of the lanthanides and actinides. Examples include Sc, Ti, V, Cr, Mn, Fe, Co, Ni, Cu, Y, Zr, Nb, Mo, Tc, Ru, Rh, Pd, Ag, Hf, Ta, W, Re, Os, Ir, Pt, and Au.

Features and advantages of the present disclosure will be further understood upon consideration of the detailed description as well as the appended claims.

### DETAILED DESCRIPTION

The free-radically polymerizable composition comprises at least one free-radically polymerizable compound, at least one transition metal acetylacetonate coordination complex having a neutral charge, and a photolabile reducing agent.

Any free-radically polymerizable compound(s) may be used. Examples include (meth)acrylates, (meth) acrylamides, vinyl ethers (e.g., methyl vinyl ether and ethyl vinyl ether), vinyl esters (e.g., vinyl acetate and vinyl propionate), vinyl halides, styrene and substituted styrenes (e.g., α-methylstyrene and divinylstyrene), N-vinylamides (N-vinylformamide, N-vinyl acetamide, and also including N-vinyllactams such as N-vinylpyrrolidone and N-vinyl caprolactam), maleimides, and allyl and/or vinyl compounds (e.g., allylic alkenes, (e.g., propene, isomers of butene, pentene, hexene up to dodecene, isoprene, and butadiene)), and combinations thereof. As used herein, the prefix “(meth)acryl” refers to “acryl” and/or “methacryl”. The free-radically polymerizable compound(s) may have one or more (e.g., two, three, four, five, six, or more) free-radically polymerizable groups, which may be of the same or different types.

Examples of suitable(meth)acrylates and (meth)acrylamides include mono-, di-, and poly-(meth)acrylates and (meth)acrylamides such as, for example, 1,2,4-butanetriol tri(meth)acrylate, 1,3-butylene glycol di(meth)acrylate, 1,3-propanediol di(meth)acrylate, 1,4-butanediol di(meth)acrylate, 1,4-cyclohexanediol di(meth)acrylate, 1,6-hexanediol di(meth)acrylate, 1,6-hexanediol monomethacrylate monoacrylate, 2-phenoxyethyl (meth)acrylate, alkoxylated cyclohexanedimethanol di(meth)acrylates, alkoxylated hexanediol di(meth)acrylate, alkoxylated neopentyl glycol di(meth)acrylate, allyl(meth)acrylate, bis[1-(2-(meth)acryloxy)]-p-ethoxyphenyldimethylmethane, bis[1-(3-(meth)acryloxy-2-hydroxy)]-p-propoxyphenyldimethylmethane, caprolactone-modified dipentaerythritol hexa(meth)acrylate, caprolactone modified neopentyl glycol hydroxypivalate di(meth)acrylate, cyclohexanedimethanol di(meth)acrylate, diethylene glycol di(meth)acrylate, dipentaerythritol penta(meth)acrylate, dipropylene glycol di(meth)acrylate, ditrimethylolpropane tetra(meth)acrylate, ethoxylated (10)bisphenol A di(meth)acrylate, ethoxylated (20)trimethylolpropane tri(meth)acrylate, ethoxylated (3)bisphenol A di(meth)acrylate, ethoxylated (3)trimethylolpropane tri(meth)acrylate, ethoxylated (30)bisphenol A di(meth)acrylate, ethoxylated (4)bisphenol A di(meth)acrylate, ethoxylated (4) pentaerythritol tetra(meth)acrylate, ethoxylated (6)trimethylolpropane tri(meth)acrylate, ethoxylated (9)trimethylolpropane tri(meth)acrylate, ethoxylated bisphenol A di(meth)acrylate, ethyl (meth)acrylate, ethylene glycol di(meth)acrylate, 2-ethylhexyl (meth)acrylate, glycerol tri(meth)acrylate, hydroxypivalaldehyde modified trimethylolpropane di(meth)acrylate, octyl (meth)acrylate, nonyl(meth)acrylate, decyl(meth)acrylate, lauryl (meth)acrylate, tridecyl(meth)acrylate, isobornyl (meth)acrylate, isopropyl (meth)acrylate, methyl (meth)acrylate, neopentyl glycol di(meth)acrylate, n-hexyl(meth)acrylate, pentaerythritol tetra(meth)acrylate, pentaerythritol tri(meth)acrylate, polyethylene glycol (200)di(meth)acrylate, polyethylene glycol (400)di(meth)acrylate, polyethylene glycol (600)di(meth)acrylate, propoxylated (3)glyceryl tri(meth)acrylate, propoxylated (3)trimethylolpropane tri(meth)acrylate, propoxylated (5.5)glyceryl tri(meth)acrylate, propoxylated (6)trimethylolpropane tri(meth)acrylate), propoxylated neopentyl glycol di(meth)acrylate, sorbitol hexa(meth)acrylate, stearyl (meth)acrylate, tetraethylene glycol di(meth)acrylate, tetrahydrofurfuryl (meth)acrylate, tricyclodecanedimethanol di(meth)acrylate, triethylene glycol di(meth)acrylate, trimethylolpropane tri(meth)acrylate, tripropylene glycol di(meth)acrylate, tris(2-hydroxyethyl)isocyanurate tri(meth)acrylate, (meth)acrylamide, N,N-dimethylacrylamide, N-vinylpyrrolidone, N-vinylcaprolactam, methylene bis(meth)acrylamide, diacetone(meth)acrylamide, (meth)acryloylmorpholine, urethane (meth)acrylates, polyester (meth)acrylates, epoxy (meth)acrylates, copolymerizable mixtures of (meth)acrylated monomers such as those in U.S. Pat. No. 4,652,274 (Boettcher et al.),(meth)acrylated oligomers such as those of U.S. Pat. No. 4,642,126 (Zador et al.), and poly(ethylenically-unsaturated) carbamoyl isocyanurates such as those disclosed in U.S. Pat. No. 4,648,843 (Mitra).

Other suitable(meth)acrylates include siloxane-functional (meth)acrylates as disclosed, for example, in PCT Published Application Nos. WO 00/38619 (Guggenberger et al.), WO 01/92271 (Weinmann et al.), WO 01/07444 (Guggenberger et al.), WO 00/42092 (Guggenberger et al.), and fluoropolymer-functional (meth)acrylates as disclosed in, for example, U.S. Pat. No. 5,076,844 (Fock et al.), 4,356,296 (Griffith et al.), EP 0 373 384 (Wagenknecht et al.), EP 0 201 031 (Reiners et al.), and EP 0 201 778 (Reiners et al.).

Suitable free-radically polymerizable compounds may contain hydroxyl groups and free-radically polymerizable functional groups in a single molecule. Examples of such materials include hydroxyalkyl (meth)acrylates such as 2-hydroxyethyl (meth)acrylate, 4-hydroxybutyrate, poly(propylene glycol)(meth)acrylate, 2-hydroxypropyl (meth)acrylate, glycerol mono- or di-(meth)acrylate, trimethylolpropane mono- or di-(meth)acrylate, pentaerythritol mono-, di-, and tri-(meth)acrylate, sorbitol mono-, di-, tri-, tetra-, or penta-(meth)acrylate, and 2,2-bis[4-(2-hydroxy-3-methacryloxypropoxy)phenyl]propane (bisGMA).

(Meth)acrylated oligomers and polymers may also be used. Examples include polyester (meth)acrylates, polyurethane (meth)acrylates, and (meth)acrylated epoxy (meth)acrylates. (Meth)acrylated epoxy (meth)acrylates and polyester(meth)acrylates are most preferred because they tend to have a relatively low viscosity and therefore allow a more uniform layer to be applied by the spin coating method. Specifically, preferred multifunctional (meth)acrylate oligomers include those commercially available from Allnex, Frankfurt, Germany and marketed under the trade name EBECRYL. Examples include EBECRYL 40 (tetrafunctional acrylated polyester oligomer), EBECRYL 80 (low viscosity amine-modified multifunctional acrylated polyether oligomer) EBECRYL 81 (multifunctional (meth)acrylated polyester oligomer), EBECRYL 600 (bisphenol A epoxy di(meth)acrylate), EBECRYL 605 (bisphenol A epoxy di(meth)acrylate diluted with 25% tripropylene glycol di(meth)acrylate), EBECRYL 3500 (difunctional Bisphenol-A oligomer acrylate), EBECRYL 3604 (multifunctional polyester oligomer acrylate), EBECRYL 8301-R (hexafunctional aliphatic urethane acrylate), and combinations thereof. Of these, the most preferred are EBECRYL 600, EBECRYL 605, EBECRYL 80, and EBECRYL 81.

In some embodiments, the at least one free-radically polymerizable compound comprises 5 to 30 weight percent of at least one compound having at least two (meth)acrylate groups.

The free-radically polymerizable composition may comprise an acid-functional monomer, where the acid-functional group may be an acid per se, such as a carboxylic acid, or a portion may be a salt thereof, such as an alkali metal carboxylate. Useful acid functional monomers include, but are not limited to, those selected from ethylenically unsaturated carboxylic acids, ethylenically unsaturated sulfonic acids, ethylenically unsaturated phosphonic or phosphoric acids, and mixtures thereof.

Examples of such compounds include those selected from acrylic acid, methacrylic acid, itaconic acid, fumaric acid, crotonic acid, citraconic acid, maleic acid, oleic acid, 13-carboxyethyl (meth)acrylate, 2-sulfoethyl methacrylate, styrene sulfonic acid, 2-acrylamido-2-methylpropanesulfonic acid, vinylphosphonic acid, and mixtures thereof.

Due to their availability, acid functional monomers of the acid functional copolymer are generally selected from ethylenically unsaturated carboxylic acids, i.e. (meth)acrylic acids. When even stronger acids are desired, acidic monomers include the ethylenically unsaturated sulfonic acids and ethylenically unsaturated phosphonic acids. The acid functional monomer is generally used in amounts of 0.5 to 15 parts by weight, preferably 1 to 15 parts by weight, most preferably 5 to 10 parts by weight, based on 100 parts by weight total monomer.

Typically, the polymerizable component(s) is/are present in the free-radically polymerizable composition in an amount of 10 to 99 weight percent, preferably 30 to 97 weight percent, and more preferably 50 to 95 weight percent, based on the total weight of the free-radically polymerizable composition, although other amounts may also be used.

Suitable free-radically polymerizable compounds are available from a wide variety of commercial sources such as, for example, Sartomer Co., Exton, Pennsylvania and/or can be made by known methods.

Useful transition metal acetylacetonate complexes having a neutral charge in which at least one acetoacetonate group (often two or three) is/are coordinatively bound to a single metal atom having a formal oxidation number equal to the number of acetoacetonate (i.e., acac) ligands. Examples include Mn(acac)₃, Cu(acac)₂, Co(acac)₃, Cr(acac)₃, Ir(acac)₃, Ni(acac)₂, Rh(acac)₃, Fe(acac)₃, and V(acac)₃, all of which are commercially available and/or can be made according to known methods. Preferably, the transition metal comprises manganese, copper, cobalt, or vanadium. Most preferably the transition metal acetylacetonate complex is Mn(acac)₃.

Typically, the transition metal acetylacetonate complex(es) is/are present in an amount of 0.05 to 1.5 parts by weight per 100 parts by weight of the at least one free-radically polymerizable compound, although this is not a requirement.

The photolabile reducing agent is represented by the formula

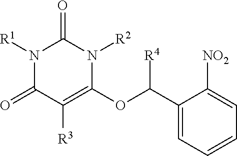

R¹, R², and R³ are independently H or a C₁-C₁₈ hydrocarbyl group (preferably a C₁-C₁₂ hydrocarbyl group, more preferably C₁-C₈ hydrocarbyl group, more preferably a C₁-C₄ hydrocarbyl group, and even more preferably methyl or ethyl). Examples of suitable hydrocarbyl groups include methyl, ethyl, propyl, isopropyl, butyl, isobutyl, pentyl, hexyl, heptyl, octyl, 2-ethylhexyl, nonyl, decyl, undecyl, dodecyl, cyclohexyl, phenyl, benzyl, and tolyl. R⁴ is H or methyl, preferably H.

Photolabile reducing agents according to the present disclosure can be prepared using techniques as generally described in the Examples according to the reaction scheme below:

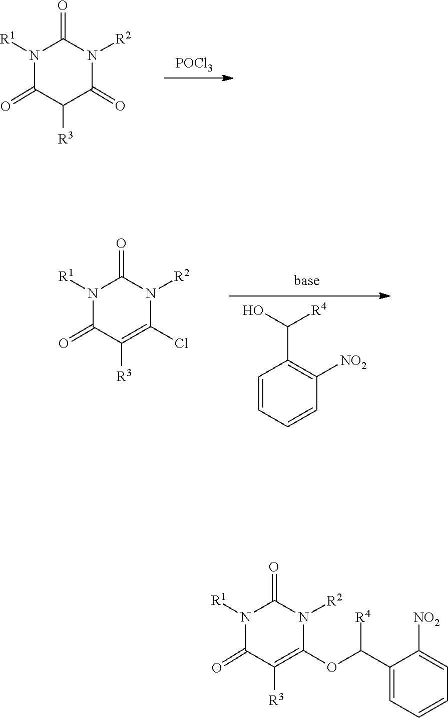

wherein R¹-R⁴ are as previously defined. Typically, the photolabile reducing agent comprises about 0.5 to about 5 parts by weight per 100 parts by weight of the at least one free-radically polymerizable compound, although other amounts may also be used.

Preferably, the photolabile reducing agent is present in an amount of no greater than 10 parts by weight, and more preferably no greater than 5 parts by weight, based on the total weight of the polymerizable components of the polymerizable composition, although this is not a requirement.

In some embodiments, the free-radically polymerizable composition is free of additional oxidizing agents (e.g., peroxides). In other embodiments, at least one additional oxidizing agent may be present.

In some embodiments, the free-radically polymerizable composition is free of added amine(s). In other embodiments, at least one added amine may be present.

The free-radically polymerizable composition may optionally include other additives. Examples of such additives include adhesion promoters, tackifiers (e.g., rosin esters, terpenes, phenols, and aliphatic, aromatic, or mixtures of aliphatic and aromatic synthetic hydrocarbon resins), surfactants, plasticizers (plasticity modifier), nucleating agents (e.g., talc, silica, or TiO₂), pigments, dyes, reinforcing agents, fillers, stabilizers (e.g., UV stabilizers and/or antioxidant stabilizers), non-reactive film-forming oligomers and/or polymers, electrically and/or thermally conductive particles, flatting agents, inert fillers, binders, blowing agents, fungicides, bactericides, and combinations thereof. The additives may be added in amounts sufficient to obtain the desired properties for the at least partially polymerized composition being produced.

In some embodiments, a toughening agent may be included. Examples include polymeric compounds having both a rubbery phase and a thermoplastic phase such as: graft polymers having a polymerized, diene, rubbery core and a poly(meth)acrylate shell; graft polymers having a rubbery, poly(meth)acrylate core with a poly(meth)acrylate shell; and elastomeric particles polymerized in situ in the epoxide from free radical polymerizable monomers and a copolymerizable polymeric stabilizer.

If present, the toughening agent is preferably used in an amount of 1-35 parts by weight, preferably 3-25 parts by weight, relative to 100 parts by weight of the free-radically polymerizable compound(s). The toughening agent may add strength to the composition after curing without reacting with the component of the polymerizable composition or interfering with curing.

In some embodiments the free-radically polymerizable composition may include one or more non-free radically polymerizable film-forming polymers. The term “film-forming organic polymer” refers to an organic polymer that will uniformly coalesce upon drying. Film-forming polymers suitable for use in the compositions are generally thermoplastic organic polymers.

Examples of suitable polymers include: polyesters (e.g., polyethylene terephthalate or polycaprolactone); copolyesters (e.g., polyethylene terephthalate isophthalate); polyamides (e.g., polyhexamethylene adipamide); vinyl polymers (e.g., poly(vinyl acetate/methyl acrylate) and poly(vinylidene chloride/vinyl acetate)); polyolefins (e.g., polystyrene and copolymers of styrene with acrylate(s) such as, for example, poly(styrene-co-butyl acrylate)); polydienes (e.g., poly(butadiene/styrene)); acrylic polymers (e.g., poly(methyl methacrylate-co-ethyl acrylate) and poly(methyl acrylate-co-acrylic acid)); polyurethanes (e.g., reaction products of aliphatic, cycloaliphatic or aromatic diisocyanates with polyester glycols or polyether glycols); and cellulosic derivatives (e.g., cellulose ethers such as ethyl cellulose and cellulose esters such as cellulose acetate/butyrate). Combinations of film-forming polymers may also be used. Methods and materials for preparing aqueous emulsions or latexes of such polymers are well known, and many are widely available from commercial sources.

In some embodiments the free-radically polymerizable composition may include filler, preferably at most 30 weight percent, and more preferably at most 10 weight percent. Fillers may be selected from one or more of a wide variety of materials, as known in the art, and include organic and inorganic filler. Inorganic filler particles include silica, submicron silica, zirconia, submicron zirconia, and non-vitreous microparticles of the type described in U.S. Pat. No. 4,503,169 (Randklev). Filler components may include nanosized silica particles, nanosized metal oxide particles, and combinations thereof. Nanofillers are also described in U.S. Pat. No. 7,090,721 (Craig et al.), 7,090,722 (Budd et al.), 7,156,911 (Kangas et al.), and 7,649,029 (Kolb et al.).

In some embodiments the filler may be surface-modified. A variety of conventional methods are available for modifying the surface of nanoparticles including, for example, adding a surface-modifying agent to nanoparticles (e.g., in the form of a powder or a colloidal dispersion) and allowing the surface-modifying agent to react with the nanoparticles. Other useful surface-modification processes are described in U.S. Pat. No. 2,801,185 (Iler), 4,522,958 (Das et al.), and 6,586,483 (Kolb et al.).

The desired properties are largely dictated by the intended application of the resultant polymeric article. These adjuvants, if present, are preferably added in an amount effective for their intended purpose.

Free-radically polymerizable compositions according to the present disclosure can generally be made by simply mixing the components. Subsequently, they are typically applied to a surface of substrate and irradiated with actinic radiation effective to cleave off the 2-nitrobenzyl group, which results in formation of a reducing agent that reduces the transition metal acetylacetonate complex to form an initiator that is effective to initiate free-radical polymerization and provide an at least partially polymerized composition. As used herein, the term “actinic radiation” means electromagnetic radiation of wavelength(s) capable of being absorbed by a composition exposed to it and thereby cause deblocking of the 2-nitrobenzyl group. Typically, ultraviolet radiation (e.g., in the range of 250-400 nm) may serve as the actinic radiation. Sources of actinic radiation may include, for example arc lamps, lasers, flash lamps (e.g., xenon flash lamp, and LED diode arrays). The selection of an appropriate light source is within the capabilities of those having ordinary skill in the art.

Free-radically polymerizable compositions according to the present disclosure, and at least partially cured free-radically polymerizable compositions according to the present disclosure are useful, for example, as adhesives (e.g., between first and second adherends), sealants, gap fillers, and/or clearcoats.

Objects and advantages of this disclosure are further illustrated by the following non-limiting examples, but the particular materials and amounts thereof recited in these examples, as well as other conditions and details, should not be construed to unduly limit this disclosure.

### Examples

Unless otherwise noted, all parts, percentages, ratios, etc. in the Examples and the rest of the specification are by weight. Preparative Examples are identified by the label prefix “PE”, Comparative Examples are identified by the label prefix “CE”, and working Examples are identified by the label prefix “E”.

Unless otherwise indicated, all other reagents were obtained, or are available from fine chemical vendors such as Sigma-Aldrich Company, St. Louis, Missouri, or may be synthesized by known methods. Table 1 (below) lists materials used in the examples and their sources.

TABLE 1

| DESIGNATION | DESCRIPTION |
|---|---|
| ABL | α-acetyl-γ-butyrolactone obtained from Alfa |
| | Aesar, Ward Hill, Massachusetts |
| Acetic | acetic anhydride obtained from EMD Millipore, |
| anhydride | Billerica, Massachusetts |
| Avobenzone | avobenzone, 1-(4-methoxyphenyl)-3-(4-tert- |
| | butylphenyl)-1,3-propanedione obtained from |
| | Rona/EM Industries, Bayonne, New Jersey |
| Benzaldehyde | benzaldehyde obtained from Sigma-Aldrich, St. |
| | Louis, Missouri |
| Benzyl tri-n- | benzyl tri-n-butylammonium chloride obtained |
| butylammonium | from Alfa Aesar |
| chloride | |
| BnDMBA | 5-benzy1-1,3-dimethylbarbituric acid synthesized |
| | as described in Preparative Example PE5 |
| b-BnDMBA | Nitrobenzyl-blocked 5-benzyl-1,3-dimethyl- |
| | barbituric acid synthesized as described in |
| | Preparative Example PE8 |
| BnMA | benzyl methacrylate obtained as MIRAMER 1183 |
| | from Miwon, Gyeonggi, South Korea |
| BuDMBA | 5-n-butyl-1,3-dimethylbarbituric acid synthesized |
| | as described in Preparative Example PE6 |
| b-BuDMBA | nitrobenzyl-blocked 5-n-butyl-1,3-dimethyl- |
| | barbituric acid synthesized as described in |
| | Preparative Example PE9 |
| CN1963 | urethane dimethacrylate obtained as CN1963 |
| | from Sartomer, Exton, Pennsylvania |
| Cu(acac)₂ | copper (II) acetylacetonate obtained from |
| | Alfa Aesar |
| Dimedone | 5,5-dimethyl-1,3-cyclohexanedione obtained |
| | from Alfa Aesar |
| 1,3-Dimethylurea | 1,3-dimethylurea obtained from Oakwood |
| | Chemicals, Estill, South Carolina |
| Dioxolane | 1,3-dioxolane obtained from BASF, Florham Park, |
| | New Jersey |
| DPPBA | 2-diphenylphosphinobenzoic acid obtained from |
| | Alfa Aesar |
| Ethyl acetate | ethyl acetate obtained from VWR, Radnor, |
| | Pennsylvania |
| HDDMA | hexanediol dimethacrylate obtained as SR239 |
| | from Sartomer |
| HEMA | 2-hydroxyethyl methacrylate obtained from TCI |
| | America, Portland, Oregon |
| HPMA | hydroxypropyl methacrylate obtained from Evonik, |
| | Essen, Germany |
| Me-b-PhDMBA | α-methyl-nitrobenzyl-blocked 5-phenyl-1,3- |
| | dimethylbarbituric acid synthesized as described |
| | in Preparative Example PE10 |
| Mn(acac)₃ | manganese(III) acetylacetonate obtained from |
| | Alfa Aesar |
| 2- | 2-nitroacetophenone obtained from TCI Company, |
| Nitroacetophenone | Tokyo, Japan |
| 2-Nitrobenzyl | 2-nitrobenzyl alcohol obtained from Alfa Aesar |
| alcohol | |
| PhDMBA | 5-phenyl-1,3-dimethylbarbituric acid synthesized |
| | as described in Preparative Example PE4 |
| b-PhDMBA | Nitrobenzyl-blocked 5-phenyl-1,3-dimethyl- |
| | barbituric acid synthesized as described in |
| | Preparative Example PE7 |
| Phenylmalonic | phenylmalonic acid obtained from Sigma-Aldrich |
| acid | |
| PHOTOMER 3016 | bisphenol A epoxy diacrylate obtained as |
| | PHOTOMER 3016 from IGM Resins, Charlotte, |
| | North Carolina |
| POCl₃ | phosphorus oxytrichloride obtained from Alfa Aesar |
| L-Proline | L-proline obtained from Alfa Aesar |
| Resin 1 | a blend of polymerizable monomers prepared as |
| | described in Preparative Example PE1 |
| Resin 2 | a blend of polymerizable monomers prepared as |
| | described in Preparative Example PE2 |
| Resin 3 | a blend of polymerizable monomers prepared as |
| | described in Preparative Example PE3 |
| Sodium | sodium borohydride obtained from Sigma-Aldrich |
| borohydride | |
| Sodium | sodium cyanoborohydride obtained from Sigma- |
| cyanoborohydride | Aldrich |
| SR541 | ethoxylated bisphenol A dimethacrylate obtained |
| | as SR541 from Sartomer |
| TS720 | fumed silica obtained as CAB-O-SIL TS720 from |
| | Cabot Corporation, Boston, Massachusetts |

### Test Methods

### IR Specimen Sandwich Construction

The components of a given mixture were combined in a 10-g max DAC cup and blended in a DAC SpeedMixer (Hauschild GmbH & Co. KG, Hamm, Germany) for 30 seconds at 2000 rpm. In cases where the curing reaction was seen to be very rapid, the mixing time was decreased to 10 seconds.

Directly after mixing, a large drop of the mixture was sandwiched between two glass microscope slides: setup consists of a top slide (2.5 cm×7.6 cm, pre-cleaned, VWR 48300-025), a bottom slide (5.1 cm×7.6 cm), pre-cleaned, VWR 48382-179), and a silicone rubber gasket (0.38 mm thick, 2.5 cm×7.6 cm) disposed therebetween, all attached with small binder clips at top and bottom. The gasket had a circle in the middle cut out to allow room for the mixture.

### Irradiation of Sandwich Specimen in Fusion UV Processor

IR Specimen Sandwich Constructions were irradiated in a Fusion UV Processor using a D-Bulb (HERAEUS NOBLELIGHT AMERICA, Gaithersburg, Maryland). Each sandwich was passed through the conveyer system once with the belt speed set to 7.6 m/sec and the D-Bulb set to 100% power. The total ultraviolet (UV) dose of this treatment was measured on an EIT PowerPuck II (EIT, Leesburg, Virginia) and reported in each individual example.

### Cure Monitoring by FTIR (Individual Spectra)

IR Specimen Sandwich Constructions were placed into a Nicolet Infrared (IR) iS50 Fourier transform spectrometer (Nicolet Thermo Fisher Scientific Inc., Waltham, Massachusetts). Spectra were taken in a range of 4000-7000 cm⁻¹. These spectra were taken at specific times that are defined in each individual example. The spectra were analyzed for disappearance of the acrylate/methacrylate overtone peak centered at 6165 cm⁻¹ (between 6095 cm⁻¹ and 6230 cm⁻¹). This disappearance was translated into a percentage (%) cure value, with complete disappearance of the peak representing 100% cure and the peak area in a reference spectrum (defined in each example) representing 0% cure.

### Cure Monitoring by FTIR (SERIES)

IR Specimen Sandwich Constructions were placed into a Nicolet IR iS50 Fourier transform spectrometer (Nicolet Thermo Fisher Scientific Inc., Waltham, Massachusetts). A series of spectra was collected in the range of 4000-7000 cm⁻¹; one spectrum being taken every 10 seconds for a total time defined in each specific example. The series of spectra were analyzed for disappearance of the acrylate/methacrylate overtone peak centered at 6165 cm⁻¹ (between 6095 cm⁻¹ and 6230 cm⁻¹). This disappearance was translated into a % cure value, with complete disappearance of the peak representing 100% cure and the peak area in a reference spectrum (defined in each example) representing 0% cure. The amount of time elapsed between creation of the mixture in the Sandwich Specimen and the first spectrum of the series is referred to as the Offset Time and is defined in each individual example.

Irradiation of Sandwich Specimen with LX-400 in FTIR Spectrometer

A given IR Sandwich Specimen was placed into a Nicolet IR iS50 Fourier transform spectrometer (Nicolet Thermo Fisher Scientific Inc., Waltham, Massachusetts). The circular cutout in the sandwich that contains the resin was irradiated by an LX-400 UV LED light source (Excelitas Technologies, Waltham, Massachusetts). The UV light had a wavelength of 365 nm, and the distance between the light source and the specimen was 1.25 cm. In some cases, this irradiation was done while a series of IR spectra was in progress. The timing details of the irradiation are defined in each individual example.

### Preparative Example PE1

Equal parts by weight of HPMA, HDDMA, and CN1963 were combined in a plastic DAC SpeedMixer cup and blended in a DAC SpeedMixer at 2000 rpm for 1 minute resulting in Resin 1.

### Preparative Example PE2

Four parts by weight of HEMA and one part by weight of PHOTOMER 3016 were combined in a plastic DAC SpeedMixer cup and blended in the DAC SpeedMixer at 2000 rpm for 1 minute resulting in Resin 2.

### Preparative Example PE3

Equal parts by weight of HEMA, BnMA, and SR541 were combined in a plastic DAC SpeedMixer cup. To the cup was added 5 parts per hundred resin TS720 fumed silica. This mixture was blended in a DAC SpeedMixer at 2000 rpm for 1 minute, stirred by hand, and blended in the DAC SpeedMixer at 2000 rpm for 1 minute again resulting in Resin 3.

### Preparative Example PE4

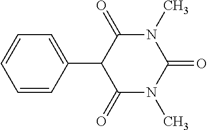 [SMILES: CN1C(=O)C(c2ccccc2)C(=O)N(C)C1=O]

To a mixture of 1,3-dimethylurea (2.66 grams, 30.0 mmol) and phenylmalonic acid (5.40 grams, 30.0 mmol) in CHCl₃ (70 mL) was added acetic acid (5.5 mL, 96.0 mmol). The resultant reaction mixture was heated at 50° C. Acetic anhydride (11.3 mL, 120.0 mmol) and trifluoroacetic acid (0.5 mL, 6.6 mmol) were added, and the reaction mixture was then heated at reflux while stirring overnight. The following morning, the volatile components were removed under reduced pressure, and the residue was added to water (100 mL). After stirring for 2 hours, the solid that formed was collected via filtration, washing with additional water. The solid was then dissolved in dichloromethane and washed with saturated aqueous sodium chloride. The organic layer was dried over anhydrous magnesium sulfate, filtered, and concentrated to afford PhDMBA (4.20 grams, 60% yield) as a white solid.

### Preparative Example PE5

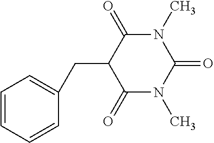 [SMILES: CN1C(=O)C(Cc2ccccc2)C(=O)N(C)C1=O]

To a mixture of 1,3-dimethylbarbituric acid (3.90 grams, 25.0 mmol) in 100 mL hot water was added a mixture of benzaldehyde (2.65 grams, 25.0 mmol) in ethanol (20 mL). The resultant mixture was stirred vigorously while heating at reflux. After 5 hours, the mixture was allowed to cool to room temperature, and the precipitate was collected via filtration, washing with additional water. After drying overnight, this provided 5-benzylidene-1,3-dimethylpyrimidine-2,4,6-trione (5.90 grams, 97% yield) as a pale yellow solid.

The 5-benzylidene-1,3-dimethylpyrimidine-2,4,6-trione (5.90 grams, 24.15 mmol) was added to ethanol (70 mL), and NaBH₄ (0.91 grams, 24.15 mmol) was added portion-wise over several minutes. After 2 hours, most of the ethanol was removed under reduced pressure, and the residue was quenched with 100 mL of aq. 1N HCl. This mixture was extracted with ethyl acetate (3×75 ml), and the combined organic layers were washed with saturated aqueous sodium chloride, dried over anhydrous magnesium sulfate, filtered, and concentrated to afford BnDMBA (5.83 grams, 98% yield) as a white crystalline solid.

### Preparative Example PE6

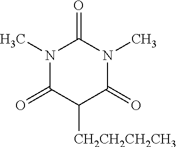

The 1,3-dimethylbarbituric acid (7.80 grams, 50.0 mmol) was dissolved in 200 mL hot deionized water in a 500 mL flask. A mixture of butyraldehyde (3.61 grams, 50.0 mmol) in 40 mL ethanol was added via pipette. The resultant mixture was stirred vigorously while heating at reflux with a heating mantle. Initially the mixture became yellowish, and a white precipitate formed, but eventually the mixture again became essentially clear. After several hours, the ethanol was removed via rotary evaporation, and the remaining aqueous layer was extracted with ethyl acetate (3×100 mL). The combined organic layers were washed with brine, dried over anhydrous magnesium sulfate, filtered, and concentrated to a pale-yellow oil (9.99 grams, 95% yield).

The intermediate barbiturate was added to 70 mL ethanol, and NaBH₄ (1.80 grams, 47.5 mmol) was added portion-wise over several minutes. The reaction was exothermic with gas evolution. Within 30 minutes the mixture had become a near colorless mixture. After 2 hours, most of the ethanol was removed via rotary evaporation, and the residue was quenched with 100 mL of aq. 1N HCl, generating a white precipitate. This mixture was extracted with ethyl acetate (3×75 ml), and the combined organic layers were washed with saturated aqueous sodium chloride, dried over anhydrous magnesium sulfate, filtered, and concentrated to afford 8.77 grams of the product (87% yield) as a yellow oil. The oil was purified via silica gel flash column (ramp eluent from 7/1 to 3.5/1 hexane/ethyl acetate), which removed most of the color and provided BuDMBA as a clear yellow oil (8.17 grams, 81% yield).

### Preparative Example PE7

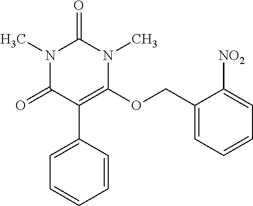 [SMILES: Cn1c(OCc2ccccc2[N+](=O)[O-])c(-c2ccccc2)c(=O)n(C)c1=O]

The 1,3-dimethyl-5-phenylbarbituric acid (4.20 grams, 18.08 mmol) was dissolved in POCl₃ (30 mL). Water (1.0 mL) was added dropwise to the mixture, resulting in a significant exotherm. Once the exotherm had subsided, the mixture was heated at reflux for 4 hours. The majority of the POCl₃ was then removed under reduced pressure, and cold water was added to the residue. The mixture was extracted with dichloromethane (3×75 mL). The combined organic layers were washed sequentially with saturated aqueous sodium bicarbonate, water, and saturated aqueous sodium chloride, then dried over anhydrous magnesium sulfate, filtered, and concentrated to provide an orange oil. Purification of this material using suction filter column (SiO₂, 3:1 hexane/ethyl acetate eluent) affords 1,3-dimethyl-5-phenyl-6-chlorouracil (4.30 grams, 95% yield) as a white solid.

Benzyl tri-n-butylammonium chloride (0.54 grams, 1.7 mmol) and 2-nitrobenzyl alcohol (3.94 grams, 25.7 mmol) were added to a solution of sodium hydroxide (3.43 grams, 85.8 mmol) in water (80 mL). A mixture of the 1,3-dimethyl-5-phenyl-6-chlorouracil (4.30 grams, 17.15 mmol) in dichloromethane (50 mL) was then added. The resultant biphasic mixture was allowed to stir vigorously overnight at room temperature. The following morning, the aqueous layer was adjusted to pH ˜6, then extracted with dichloromethane (3×75 mL). The combined organic layers were then washed sequentially with H₂O and saturated aqueous sodium chloride, then dried over anhydrous magnesium sulfate, filtered, and concentrated to an orange oil. Purification of this material via suction filter column (SiO₂, 1:1 hexane/ethyl acetate eluent) afforded b-PhDMBA (3.14 grams, 50/yield) as a white solid.

### Preparative Example PE8

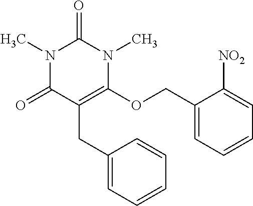 [SMILES: Cn1c(OCc2ccccc2[N+](=O)[O-])c(Cc2ccccc2)c(=O)n(C)c1=O]

1,3-Dimethyl-5-benzylbarbituric acid (7.39 grams, 30.0 mmol) was dissolved in POCl₃ (41.4 grams, 270 mmol). Water (1.35 mL) was added dropwise to the mixture, resulting in a significant exotherm. Once the exotherm had subsided, the mixture was heated at reflux for 3 hours. The majority of the POCl₃ was then removed under reduced pressure, and cold water was added to the residue. The mixture was extracted with dichloromethane (3×75 mL). The combined organic layers were washed sequentially with saturated aqueous sodium bicarbonate, water, and saturated aqueous sodium chloride, then dried over anhydrous magnesium sulfate, filtered, and concentrated to provide an orange oil. Purification of this material via suction filter column (SiO₂, 7:1 hexane/ethyl acetate eluent) afforded 1,3-dimethyl-5-benzyl-6-chlorouracil (7.94 grams, quantitative yield) as an orange oil which slowly crystallized to a solid.

Benzyl tri-n-butylammonium chloride (0.94 grams, 3.0 mmol) and 2-nitrobenzyl alcohol (6.13 grams, 40.0 mmol) were added to a mixture of sodium hydroxide (6.0 grams, 150 mmol) in H₂O (90 mL). A mixture of the 1,3-dimethyl-5-benzyl-6-chlorouracil (7.94 grams, 30.0 mmol) in dichloromethane (70 mL) was then added. The resultant biphasic mixture was allowed to stir vigorously overnight at room temperature. The following morning, the aqueous layer was adjusted to pH ˜6, then extracted with dichloromethane (3×75 mL). The combined organic layers were then washed sequentially with H₂O and saturated aqueous sodium chloride, then dried over anhydrous magnesium sulfate, filtered, and concentrated to an orange oil. Purification of this material via suction filter column (SiO₂, ramp eluent from 7:1 hexane/ethyl acetate to ethyl acetate) afforded b-BnDMBA (4.20 grams, 37% yield) as a light peach colored solid.

### Preparative Example PE9

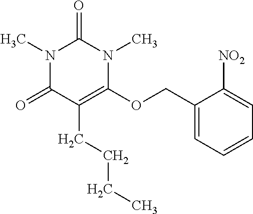 [SMILES: CCCCc1c(OCc2ccccc2[N+](=O)[O-])n(C)c(=O)n(C)c1=O]

The starting 2-butyl-1,3-dimethylbarbituric acid (6.37 grams, 30.0 mmol) was dissolved in POCl₃ (25.2 mL, 270 mmol, 9.0 eq.). Water (1.35 mL, 75 mmol, 2.5 eq.) was added dropwise; exotherm with gas evolution was noted. Once the exotherm had subsided, the resultant clear, yellow solution was heated to −70° C. with a heating mantle. The solution remained clear and became darker in color (yellow to orange to red). After 4 hours, thin layer chromatography (TLC) indicated essentially complete conversion to product. The bulk of the POCl₃ was removed using a rotary evaporator, and the residue was quenched with cold water (careful, exothermic quenching of POCl₃). The mixture was then extracted with dichloromethane (3×75 mL), and the combined organic layers were washed sequentially with water, saturated aqueous sodium bicarbonate, and brine, then dried over anhydrous magnesium sulfate, filtered, and concentrated. Purification via suction filter column (SiO₂, 9/1 hexane/ethyl acetate eluent) provided the chlorouracil product as a pale-yellow oil (6.51 grams, 94% yield).

The chlorouracil from previous step (6.51 grams, 28.1 mmol) was dissolved in dichloromethane (70 mL). 2-Nitrobenzyl alcohol (5.74 grams, 37.5 mmol) and benzyl tri-n-butylammonium chloride (0.88 grams, 2.8 mmol) were added. Then a solution of sodium hydroxide (5.6 grams, 141 mmol) in H₂O (90 mL) was added to generate a biphasic reaction mixture which was vigorously stirred at room temperature overnight. The following morning, TLC indicated clean reaction, but a significant amount of chlorouracil remained. The reaction mixture was heated with a heating mantle for an additional 12 hours; by TLC this appeared to help, but reaction still did not proceed to completion. Color was a very dark red at this point. 1N aq. HCl was added to the aqueous layer until the pH was ˜5-6, then extracted with dichloromethane (3×). The combined organic layers were washed with water and brine, then dried over anhydrous magnesium sulfate and filtered. The crude product was adsorbed onto silica gel and purified using a suction filter column, the eluent ramped from 9/1 hexane/ethyl acetate to 1/1 hexane/ethyl acetate. b-BuDMBA, 3.42 g, (35% yield) was obtained as a yellow oil.

### PREPARATIVE EXAMPLE PE10

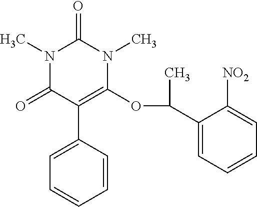 [SMILES: CC(Oc1c(-c2ccccc2)c(=O)n(C)c(=O)n1C)c1ccccc1[N+](=O)[O-]]

Preparation of 1-(2-nitrophenyl)ethanol: 2-nitroacetophenone (16.52 grams, 100.0 mmol) was dissolved in THF (100 mL) and cooled in an ice bath. Sodium borohydride (4.16 grams, 110.0 mmol) was added portion-wise over several minutes. Over several hours, the reaction mixture became dark red, with no exotherm noted. The ice bath was removed, and 50 mL ethanol was added. The resultant mixture was heated gently with a heating mantle. The color then began to change to a lighter yellow, and the borohydride appeared to react. The bulk of the solvents were removed using a rotary evaporator. Water was added to the residue, followed by enough 1N HCl to get to acidic pH; this resulted in removal of most of the yellow coloring. Extract with ethyl acetate (2×100 mL). The combined extracts were washed with brine, dried over anhydrous magnesium sulfate, filtered, and concentrated to a tan oil (˜20.0 grams). ¹H NMR showed very clean conversion to desired 1-(2-nitrophenyl) ethanol, with significant amounts of ethyl acetate present accounting for the mass in excess of theoretical yield.

To a mixture of the chlorouracil (2.51 grams, 10.0 mmol) and 1-(2-nitrophenyl) ethanol (3.34 grams, 20.0 mmol) in MEK (30 mL) was added cesium carbonate (6.52 grams, 20.0 mmol). The resultant mixture was allowed to stir at room temperature overnight. The following day, thin layer chromatography and ¹H NMR analysis indicated that the chlorouracil was essentially completely consumed, with clean formation of desired product. Water was added to the mixture, generating a clear biphasic mixture; addition of hexane and vigorous stirring then caused a white precipitate to form. The precipitate was collected via filtration, providing 2.73 grams (72% yield) of product as a white solid. ¹H NMR (d₆-DMSO) was clean and consistent with Me-b-PhDMBA.

### Comparative Examples CE1-A to CE1-E

The mixtures in Table 2 were made in 20-mL glass vials, blended on a vortex mixer for 30 sec, and allowed to sit at room temperature. Some of the mixtures were further treated as described in Table 2 under “Treatment to Dissolve” (using an oven and a vortex mixer). The mixtures were made to have 1 mmol of reducing agent in 5 g of mixture.

TABLE 2

| STOCK | | | | |
|---|---|---|---|---|
| MIXTURE | COMPONENT 1 | COMPONENT 2 | COMPONENT 3 | TREATMENT TO DISSOLVE |
| Mn Stock 1 | 200 mg Mn(acac)₃ | 19.800 g Resin 1 | — | 30 min at 55° C. |
| ABL Stock 1 | 128 mg ABL | 4.870 g Resin 1 | — | Miscible liquid |
| PhDMBA Stock 1 | 232 mg PhDMBA | 4.770 g Resin 1 | 1.000 g propylene | Combine PhDMBA and propylene carbonate, |
| | | | carbonate | heat 10 min at 75° C., then add Resin 1. |
| Dimedone Stock 1 | 140 mg Dimedone | 4.860 g Resin 1 | — | 60 min at 55° C. |
| BnDMBA Stock 1 | 246 mg BnDMBA | 4.750 g Resin 1 | — | 30 min at 55° C. |
| Avobenzone Stock 1 | 310 mg Avobenzone | 4.690 g Resin 1 | — | 30 min at 55° C. |

The mixtures in Table 3 were made in 4-mL glass vials, blended on a vortex mixer for 10 sec, and allowed to sit at room temperature. They were monitored for qualitative evidence of polymerization. Results are reported in Table 3. Table 4 reports all components in each formulation in Table 3.

TABLE 3

| COMPARATIVE | | 0 TO 5 | | | | |
|---|---|---|---|---|---|---|
| EXAMPLE | MIXTURE | MINUTES | 10 MINUTES | 1 HOUR | 1 DAY | 8 DAYS |
| CE1-A | 1.000 g ABL Stock 1 + | No change, dark | Exotherm to hard | Hard yellow | Hard yellow solid | Hard yellow |
| | 1.000 g Mn Stock 1 | solution | yellow solid | solid | | solid |
| CE1-B | 1.000 g Dimedone Stock 1 + | No change, dark | No change, dark | Dark | Hard dark solid | Hard dark solid |
| | 1.000 g Mn Stock 1 | solution | solution | solution | under thin liquid | under thin liquid |
| | | | | | layer | layer |
| CE1-C | 1.000 g BnDMBA Stock 1 + | Exotherm to hard | Hard yellow solid | Hard yellow | Hard yellow solid | Hard yellow |
| | 1.000 g Mn Stock 1 | yellow solid | | solid | | solid |
| CE1-D | 1.000 g Avobenzone Stock | No change, dark | No change, dark | Dark | Dark solution | Dark solution |
| | 1 + 1.000 g Mn Stock 1 | solution | solution | solution | | |
| CE1-E | 1.200 g PhDMBA Stock 1 + | Exotherm to hard | Hard yellow solid | Hard yellow | Hard yellow solid | Hard yellow |
| | 1.000 g Mn Stock 1 | yellow solid | | solid | | solid |

TABLE 4

| | | GRAMS | | | | | |
|---|---|---|---|---|---|---|---|
| COMPARATIVE | REDUCING | REDUCING | | | | | PROPYLENE |
| EXAMPLE | AGENT | AGENT | Mn(acac)₃ | HPMA | HDDMA | CN1963 | CARBONATE |
| CE1-A | ABL | 0.026 | 0.010 | 0.655 | 0.655 | 0.655 | — |
| CE1-B | Dimedone | 0.028 | 0.010 | 0.654 | 0.654 | 0.654 | — |
| CE1-C | BnDMBA | 0.049 | 0.010 | 0.647 | 0.647 | 0.647 | — |
| CE1-D | Avobenzone | 0.062 | 0.010 | 0.643 | 0.643 | 0.643 | — |
| CE1-E | PhDMBA | 0.046 | 0.010 | 0.648 | 0.648 | 0.648 | 0.200 |

### Examples E2-A, E2-B, and COMPARATIVE EXAMPLE CE2-A

The mixtures in Table 5 were made in 20-mL glass vials, blended on a vortex mixer for 30 sec, and allowed to sit at room temperature. Some of the mixtures were further treated as described in Table 5 under “Solubility Notes” (using an oven and a vortex mixer). The mixtures were made to have 1 mmol of blocked reducing agent in 5 g of mixture. They were monitored for qualitative evidence of polymerization. Results and compositions are reported in Tables 5 and 6.

TABLE 5

| STOCK | | COMPONENT 2, | SOLUBILITY |
|---|---|---|---|
| MIXTURE | COMPONENT 1 | g of Resin 2 | NOTES |
| Mn Stock 2 | 200 mg | 19.800 | 30 min at 55° C., |
| | Mn(acac)₃ | | stirring. |
| | | | Dark solution. |
| b-PhDMBA | 367 mg | 4.630 | 30 min at 55° C., |
| Stock 2 | b-PhDMBA | | stirring. |
| | | | Partially soluble. |
| b-BnDMBA | 381 mg | 4.620 | 30 min at 55° C., |
| Stock 2 | b-BnDMBA | | stirring. |
| | | | Partially soluble. |

TABLE 6

| | | GRAMS | | | |
|---|---|---|---|---|---|
| EXAMPLE | REDUCING AGENT | REDUCING AGENT | Mn(acac)₃ | HEMA | PHOTOMER 3016 |
| E2-A Dark | b-PhDMBA | 0.073 | 0.010 | 1.533 | 0.383 |
| E2-B Dark | b-BnDMBA | 0.076 | 0.010 | 1.531 | 0.383 |
| E2-A Light | b-PhDMBA | 0.073 | 0.010 | 1.533 | 0.383 |
| E2-B Light | b-BnDMBA | 0.076 | 0.010 | 1.531 | 0.383 |

Mixtures containing the blocked reducing agents, Resin 2, and Mn(acac)₃ stock mixtures were made in 4-mL glass vials, blended on a vortex mixer for 10 sec, and allowed to sit at room temperature. This was done to test the “dark stability” of the blocked reducing agents. Results are reported in Table 7, below.

TABLE 7

| EXAMPLE | MIXTURE | 60 MINUTES | 26 HOURS | 2 DAYS | 22 DAYS |
|---|---|---|---|---|---|
| E2-A Dark | 1.000 g of b-PhDMBA Stock 2, + | Dark solution, some | Dark solution, some | Dark solution, some | Yellow solid, dark liquid |
| | 1.000 g of Mn Stock 2 | precipitate | precipitate | precipitate | on top, some precipitate |
| E2-B Dark | 1.000 g of b-BnDMBA Stock 2, | Dark solution, some | Dark solution, some | Dark solution, some | Yellow solid, liquid |
| | 1.000 g of Mn Stock 2 | precipitate | precipitate | precipitate | on top |

Example mixtures E2-A and E2-B were subjected to light and dark cure screening experiments. A drop of mixture was placed on a glass slide and covered with a coverslip. Some of these covered drops (those labeled “Light”) were subjected to the Fusion Processor D bulb at 100 percent power for 1 pass at 25 fpm (7.6 m/min). The radiometry from an EIT PowerPuck showed the following measurements: 2500 mJ/cm² UVA, 540 mJ/cm² UVB, 230 mJ/cm² UVC, 2460 mJ/cm² UVV. After coverslip specimen formation (and sometimes irradiation), the specimens were monitored for curing of the resin. When the coverslip was stuck to the bottom glass slide, the resin was considered cured.

As a Comparative Example, pure Mn Stock 2 was also subjected to the coverslip/light treatment. The results are reported in Table 8, below.

TABLE 8

| | | MINUTES | | | | | |
|---|---|---|---|---|---|---|---|
| EXAMPLE | MIXTURE | 5 | 15 | 30 | 60 | 2 HOURS | 1 DAY |
| E2-A Light | 1.000 g b-PhDMBA Stock 2, | Cured | Cured | Cured | Cured | Cured | Cured |
| | 1.000 g Mn Stock 2 | | | | | | |
| E2-B Light | 1.000 g b-BnDMBA Stock 2, | No Curing | Slight | Slight | Partially | Cured | Cured |
| | 1.000 g Mn Stock 2 | | curing | curing | cured | | |
| COMPARATIVE | All Mn Stock 2 | No Curing | No Curing | No Curing | No Curing | No Curing | Partially cured |
| EXAMPLE | | | | | | | |
| CE2-A Light | | | | | | | |
| E2-A Dark | 1.000 g b-PhDMBA Stock 2, | No Curing | No Curing | No Curing | No Curing | No Curing | No Curing |
| | 1.000 g Mn Stock 2 | | | | | | |
| E2-B Dark | 1.000 g b-BnDMBA Stock 2, | No Curing | No Curing | No Curing | No Curing | No Curing | No Curing |
| | 1.000 g Mn Stock 2 | | | | | | |

### Examples E3-A, E3-B and Comparative Examples CE3-A to CE3-C

The mixtures in Table 9 were made in 20-n glass vials, blended on a vortex mixer for 30 sec and allowed to sit at room temperature. Some of the mixtures were further treated as reported in Table 9 (below) under “Treatment to Dissolve” (using an oven and a vortex mixer).

TABLE 9

| STOCK | COMPONENT | COMPONENT | TREATMENT TO |
|---|---|---|---|
| MIXTURE | 1 | 2 | DISSOLVE |
| b-PhDMBA | 367 mg | 7.130 g | 30 min at 55° C., |
| Stock 3 | b-PhDMBA | HEMA | stirring |
| b-BnDMBA | 381 mg | 7.120 g | 30 min at 55° C., |
| Stock 3 | b-BnDMBA | HEMA | stirring |
| Mn Stock 3 | 50 mg | 4.950 g | 30 min at 55° C., |
| | Mn | Resin 2 | stirring |

The heated stock mixtures were cooled and used to make mixtures that were loaded into IR sandwich specimens according to the Test Method for IR Specimen Sandwich Construction as reported in Table 10, and in greater detail in Table 11, both below.

TABLE 10

| | MIXTURE | MIXTURE |
|---|---|---|
| EXAMPLE | COMPONENT 1 | COMPONENT 2 |
| E3-A Light | 1.500 g, b- | 1.000 g, Mn |
| | PhDMBA Stock 3 | Stock 3 |
| E3-A Dark | 1.500 g, b- | 1.000 g, Mn |
| | PhDMBA Stock 3 | Stock 3 |
| E3-B Light | 1.500 g, b- | 1.000 g, Mn |
| | BnDMBA Stock 3 | Stock 3 |
| E3-B Dark | 1.500 g, b- | 1.000 g, Mn |
| | BnDMBA Stock 3 | Stock 3 |
| COMPARATIVE | 1.500 g, b- | 1.000 g, |
| EXAMPLE CE3-A Light | PhDMBA Stock 3 | Resin 2 |
| COMPARATIVE | 1.500 g, b- | 1.000 g, |
| EXAMPLE CE3-B Light | BnDMBA Stock 3 | Resin 2 |
| COMPARATIVE | 1.500 g, HEMA | 1.000 g, Mn |
| EXAMPLE CE3-C Light | | Stock 3 |

TABLE 11

| | GRAMS | | | | |
|---|---|---|---|---|---|
| EXAMPLE | b-PhDMBA | b-BnDMBA | Mn(acac)₃ | HEMA | PHOTOMER 3016 |
| E3-A Light | 0.073 | — | 0.010 | 2.219 | 0.198 |
| E3-A Dark | 0.073 | — | 0.010 | 2.219 | 0.198 |
| E3-B Light | — | 0.076 | 0.010 | 2.216 | 0.198 |
| E3-B Dark | — | 0.076 | 0.010 | 2.216 | 0.198 |
| COMPARATIVE EXAMPLE CE3-A Light | 0.073 | — | — | 2.227 | 0.200 |
| COMPARATIVE EXAMPLE CE3-B Light | — | 0.076 | — | 2.224 | 0.200 |
| COMPARATIVE EXAMPLE CE3-C Light | — | — | 0.010 | 2.292 | 0.198 |

An initial IR spectrum of each of the Example sandwich specimens was taken within 15 minutes of their creation. The methacrylate peak area from the initial spectrum of each sandwich was used as the reference (0% cure) for further analysis of the same sandwich.

Some of the Example sandwich specimens (those labeled “Light”) were irradiated in the Fusion Processor according to the Test Method (D Bulb, 100% power, 25 fpm (7.6 m/min), 1 pass). In this way, Example E3-A Light and Comparative Example CE3-A Light were subjected to 2500 mJ/cm² UVA, 550 mJ/cm² UVB, 240 mJ/cm² UVC, and 2500 mJ/cm² UVV as measured by an EIT PowerPuck 2. In this way, Examples E3-B Light and Comparative Examples CE3-B Light and CE3-C Light were subjected to 2300 mJ/cm² UVA, 520 mJ/cm² UVB, 240 mJ/cm² UVC, and 2400 mJ/cm² UVV as measured by an EIT PowerPuck 2.

Each of the Example sandwiches was monitored for curing by IR according to the Test Method for Cure Monitoring by IR (Individual Spectra). The methacrylate peak area from the initial spectrum of each sandwich was used as the reference (0% cure) for further analysis of the same sandwich. Further spectra were taken at approximately 2.5 hours after creation (for Dark specimens) or irradiation (for Light specimens). Final spectra were taken 3 days later (for Examples E3-A Light, E3-A Dark, and Comparative Example CE3-A Light) or 4 days later (for Examples E3-B Light, E3-B Dark, Comparative Examples CE3-B Light and CE3-C Light). The results of these analyses are reported in Table 12.

TABLE 12

| | | % CURE AFTER | % CURE AFTER | % CURE AFTER | APPEARANCE | APPEARANCE |
|---|---|---|---|---|---|---|
| EXAMPLE | CURATIVES | 2.5 HOURS | 3 DAYS | 4 DAYS | AFTER 3 DAYS | AFTER 4 DAYS |
| E3-A Light | b-PhDMBA, | 58.2 | 58.7 | — | solid | — |
| | Mn(acac)₃ | | | | | |
| E3-A Dark | b-PhDMBA, | 4.6 | N/A** | — | liquid | — |
| | Mn(acac)₃ | | | | | |
| E3-B Light | b-BnDMBA, | 16.5 | — | 15.3 | — | medium gel |
| | Mn(acac)₃ | | | | | |
| E3-B Dark | b-BnDMBA, | −0.2* | — | −0.3* | — | liquid |
| | Mn(acac)₃ | | | | | |
| COMPARATIVE | b-PhDMBA | 7.4 | 7.5 | — | liquid with some | — |
| EXAMPLE | | | | | gel | |
| CE3-A Light | | | | | | |
| COMPARATIVE | b-BnDMBA | 0.5 | — | 3.3 | — | liquid |
| EXAMPLE | | | | | | |
| CE3-B Light | | | | | | |
| COMPARATIVE | Mn(acac)₃ | −0.3* | — | −0.2%* | — | liquid |
| EXAMPLE | | | | | | |
| CE3-C Light | | | | | | |

*A methacrylate peak area bigger than the original gave a “negative % cure” but was assumed to be 0% cure within the margin of error.
**The specimen was ruined because the liquid leaked, and bubbles arose.

### Comparative Examples CE4-A to CE4-D

The curing behavior of mixtures including Mn(acac)₃ and unblocked versions of the reducing agents was quantitatively investigated using FITR. The mixtures in Table 13 were made in 20-mL glass vials, blended on a vortex mixer for 30 sec, and allowed to sit at room temperature. Some of the mixtures were further treated as described in Table 13 under “Treatment to Dissolve” (using an oven and a vortex mixer).

TABLE 13

| STOCK | | | TREATMENT TO |
|---|---|---|---|
| MIXTURE | COMPONENT 1 | COMPONENT 2 | DISSOLVE |
| PhDMBA | 246 mg, | 7.250 g, | Stirring |
| Stock 4 | PhDMBA | HEMA | |
| BnDMBA | 232 mg, | 7.270 g, | Stirring |
| Stock 4 | BnDMBA | HEMA | |
| Mn | 50 mg, | 4.950 g, | 10 min at 55° C., |
| Stock 4 | Mn(acac)₃ | Resin 2 | stirring |

Both unblocked reducing agents were easily soluble in HEMA after stirring at room temperature. The stock mixtures were used to make mixtures that were loaded into IR sandwich specimens according to the Test Method for IR Specimen Sandwich Construction as reported in Table 14, and greater detail in Table 15 (both below).

TABLE 14

| COMPARATIVE | MIXTURE | |
|---|---|---|
| EXAMPLE | COMPONENT 1 | COMPONENT 2 |
| CE4-A Dark | 1.500 g, PhDMBA Stock 4 | 1.000 g, Mn Stock 4 |
| CE4-B Dark | 1.500 g, BnDMBA Stock 4 | 1.000 g Mn Stock 4 |
| CE4-C Dark | 1.500 g, PhDMBA Stock 4 | 1.000 g, Resin 2 |
| CE4-D Dark | 1.500 g, BnDMBA Stock 4 | 1.000 g, Resin 2 |

TABLE 15

| | GRAMS | | | | |
|---|---|---|---|---|---|
| COMPARATIVE | | | | | PHOTOMER |
| EXAMPLE | PhDMBA | BnDMBA | Mn(acac)₃ | HEMA | 3016 |
| CE4-A Dark | 0.049 | — | 0.010 | 2.243 | 0.198 |
| CE4-B Dark | — | 0.046 | 0.010 | 2.246 | 0.198 |
| CE4-C Dark | 0.049 | — | — | 2.251 | 0.200 |
| CE4-D Dark | — | 0.046 | — | 2.254 | 0.200 |

Initial IR spectra of Comparative Examples CE4-C Dark and CE4-D Dark were taken within 15 minutes of their creation. The methacrylate peak area from the initial spectrum of CE4-C Dark was used as the reference (0% cure) for further analysis of CE4-A Dark (an accurate initial reference spectrum of CE4-A Dark was impossible to obtain because the mixture began reacting so quickly). Similarly, the methacrylate peak area from the initial spectrum of CE4-D was used as the reference (0% cure) for further analysis of CE4-B Dark for the same reason. None of the sandwiches were irradiated with UV light in this experiment.

Comparative Examples CE4-A Dark and CE4-B Dark were analyzed for real-time curing according to the Test Method for Cure Monitoring by IR (Series). The Offset Time (time between mixing and the beginning of the series collection) was 2 minutes for both CE4-A Dark and CE4-B Dark. The initial reference spectra for the series analysis were the respective initial spectra from CE4-C Dark and CE4-D Dark as discussed above.

Each of the sandwiches in Table 14 was also monitored for curing by IR according to the Test Method for Cure Monitoring by IR (Individual Spectra). Unfortunately, Comparative Examples CE4-C Dark and CE4-D Dark partially leaked out of their sandwiches as they were stored, so no further spectra could be obtained from them beyond the initial spectra. The appearances of the materials and the % cure from the series data were noted 30 minutes after mixing CE4-C Dark and CE4-D Dark. Final spectra of CE4-A Dark and CE4-B Dark were taken (and appearances of the materials noted) 5 days after creation. The results of these analyses are compiled in Table 16, below.

TABLE 16

| | | | | % CURE | |
|---|---|---|---|---|---|
| COMPARATIVE | | % CURE AFTER 30 MIN | APPEARANCE AFTER | AFTER 5 | APPEARANCE AFTER |
| EXAMPLE | CURATIVES | (FROM SERIES DATA) | 30 MINUTES | DAYS | 5 DAYS |
| CE4-A Dark | PhDMBA, Mn(acac)₃ | 74.0% | hard hazy solid (in vial) | 90.2% | hard hazy solid (in sandwich) |
| CE4-B Dark | BnDMBA, Mn(acac)₃ | 90.0% | hard orange solid (in vial) | 92.2% | hard clear solid (in sandwich) |
| CE4-C Dark | PhDMBA | N/A* | clear liquid (in vial) | n/a* | hard, clear solid (in sandwich) |
| CE4-D Dark | BnDMBA | N/A* | yellow liquid (in vial) | n/a* | medium clear solid (in sandwich) |

*The sandwich specimen was ruined because the liquid leaked, and bubbles arose.

### Examples E5-A and E5-B

The curing behavior of mixtures including Mn(acac)₃ and 0.5 weight percent b-PhDMBA was quantitatively assessed using FTR. The mixtures in Table 17 were made in 20-mL glass vials, blended on a vortex mixer for 30 sec, and allowed to sit at room temperature. Some of the mixtures were further treated as described in Table 17 under “Treatment to Dissolve” (using an oven and a vortex mixer).

TABLE 17

| STOCK | | | TREATMENT TO |
|---|---|---|---|
| MIXTURE | COMPONENT 1 | COMPONENT 2 | DISSOLVE |
| b-PhDMBA | 367 mg b- | 7.130 g HEMA | 30 min at 55° C., |
| Stock 5 | PhDMBA | | stirring |
| Mn Stock 5 | 50 mg Mn(acac)₃ | 4.950 g Resin 2 | 30 min at 55° C., |
| | | | stirring |

The stock mixtures were used to make mixtures that were loaded into IR sandwich specimens according to the Test Method for IR Specimen Sandwich Construction as reported in Table 18, and in greater detail in Table 19, both below.

TABLE 18

| | MIXTURE | MIXTURE | MIXTURE | MIXTURE |
|---|---|---|---|---|
| EXAMPLE | COMPONENT 1 | COMPONENT 2 | COMPONENT 3 | COMPONENT 4 |
| E5-A Dark | 0.260 g, | 0.170 g, | 0.990 g, | 1.080 g, |
| | b-PhDMBA Stock 6 | Mn Stock 5 | HEMA | Resin 2 |
| E5-A Light | 0.260 g, | 0.170 g, | 0.990 g, | 1.080 g, |
| | b-PhDMBA Stock 6 | Mn Stock 5 | HEMA | Resin 2 |
| E5-B Dark | 0.260 g, | 1.200 g, | 0.990 g, | 0.050 g, |
| | b-PhDMBA Stock 6 | Mn Stock 5 | HEMA | Resin 2 |
| E5-B Light | 0.260 g, | 1.200 g, | 0.990 g, | 0.050 g, |
| | b-PhDMBA Stock 6 | Mn Stock 5 | HEMA | Resin 2 |

TABLE 19

| | GRAMS | | | |
|---|---|---|---|---|
| EXAMPLE | b-PHDMBA | Mn(acac)₃ | HEMA | PHOTOMER 3016 |
| E5-A Dark | 0.013 | 0.002 | 2.236 | 0.250 |
| E5-A Light | 0.013 | 0.002 | 2.236 | 0.250 |
| E5-B Dark | 0.013 | 0.012 | 2.227 | 0.248 |
| E5-B Light | 0.013 | 0.012 | 2.227 | 0.248 |

An initial IR spectrum of: E-A Light and E5-B Light was taken within 15 minutes of their creation(prior to irradiation). The methacrylate peak area from the initial spectrum E-A Light was used as the reference (0% cure) for further analysis of E5-A Light and E5-A Dark. Likewise, further analysis of EE5-B Light and E-B Dar was referenced to the initial spectrum from E-B Light.

Some of the Example sandwich specimens (those labeled “Light”) were irradiated in the Fusion Processor according to the General Procedure (D Bulb, 100% power, 25 fpm (7.6 m/min), 1 pass). In this way, ES-A Light was subjected to 2120 mJ/cm² UVA, 480 mJ/cm² UVB, 230 mJ/cm² UVC, and 2260 mJ/cm² UW as measured by an EIT PowerPuck 2. In this way, ES-B Light was subjected to 2250 mJ/cm² UVA, 500 mJ/cm² UVB, 230 mJ/cm² UVC, and 2330 mJ/cm² UW as measured by an EIT PowerPuck 2.

Each of the sandwiches in Table 18 was monitored for curing by IR spectroscopy according to the Test Method for Cure Monitoring by IR (Individual Spectra). Spectra were taken at approximately 2.5 hours after creation (for Dark specimens) or irradiation (for Light specimens). Final spectra were taken S days later. The results of these analyses are compiled in Table 20, below.

TABLE 20

| | | % CURE | % CURE | APPEARANCE |
|---|---|---|---|---|
| | b-PHDMBA:Mn | AFTER 2.5 | AFTER 5 | AFTER 5 |
| EXAMPLE | RATIO | HOURS | DAYS | DAYS |
| E5-A Dark | 7:1 | 1.6% | 4.8% | medium gel |
| E5-A Light | 7:1 | 9.9%** | 46.1% | yellow liquid |
| E5-B Dark | 1:1 | −0.1%* | 15.6% | soft gel + liquid |
| E5-B Light | 1:1 | 3.7% | 7.1% | dark liquid |

*A methacrylate peak area bigger than the original gives a “negative % cure” but was assumed to be 0% cure within the margin of error.
**These data were taken from the last spectrum of the IR series on E5-A Light, whose collection time was approximately 2 hours after irradiation.

### Examples E6-A to E6-C and Comparative Examples CE6-A to CE6-C

In this example, various molar ratios of both PhDMBA and b-PhDMBA to Mn(acac)₃ were explored. The loading of blocked reducing agent in the formulations was 1.5 weight percent, and the loading of unblocked reducing agent was chosen to match that molar amount. Dioxolane (to promote solubility of reagents) was also added. The mixtures in Table 21 were made in 20-mL glass vials, blended on a vortex mixer for 30 sec, and allowed to sit at room temperature.

TABLE 21

| STOCK | | | TREATMENT |
|---|---|---|---|
| MIXTURE | COMPONENT 1 | COMPONENT 2 | TO DISSOLVE |
| PhDMBA | 0.500 g | 4.500 g | stirring at room |
| Stock 6 | PhDMBA | dioxolane | temperature |
| b-PhDMBA | 0.500 g | 4.500 g | stirring at room |
| Stock 6 | b-PhDMBA | dioxolane | temperature |
| Mn Stock 6 | 0.500 g | 4.500 g | stirring at room |
| | Mn(acac)₃ | dioxolane | temperature |

The stock mixtures were used to make mixtures that were loaded into IR sandwich specimens according to the Test Method for IR Specimen Sandwich Construction as reported in Table 22 and Table 23 in greater detail, both below.

TABLE 22

| | MIXTURE | MIXTURE | MIXTURE | MIXTURE |
|---|---|---|---|---|
| EXAMPLE | COMPONENT 1 | COMPONENT 2 | COMPONENT 3 | COMPONENT 4 |
| COMPARATIVE | 284 mg, | 431 mg, | 3.000 g, | 0.170 g |
| EXAMPLE | PhDMBA Stock 6 | Mn Stock 6 | Resin 3 | dioxolane |
| CE6-A | | | | |
| COMPARATIVE | 284 mg, | 86 mg, | 3.000 g, | 0.510 g |
| EXAMPLE | PhDMBA Stock 6 | Mn Stock 6 | Resin 3 | dioxolane |
| CE6-B Dark | | | | |
| COMPARATIVE | 284 mg, | 43 mg, | 3.000 g, | 0.550 g |
| EXAMPLE | PhDMBA Stock 6 | Mn Stock 6 | Resin 3 | dioxolane |
| CE6-C Dark | | | | |
| E6-A Light | 450 mg, | 431 mg, | 3.000 g, | — |
| | b-PhDMBA Stock 6 | Mn Stock 6 | Resin 3 | |
| E6-B Light | 450 mg, | 86 mg, | 3.000 g, | 0.350 g |
| | b-PhDMBA Stock 6 | Mn Stock 6 | Resin 3 | dioxolane |
| E6-C Light | 450 mg, | 43 mg, | 3.000 g, | 0.390 g |
| | b-PhDMBA Stock 6 | Mn Stock 8 | Resin 3 | dioxolane |

TABLE 23

| | GRAMS | | | | | | | |
|---|---|---|---|---|---|---|---|---|
| EXAMPLE | PHDMBA | b-PHDMBA | Mn(acac)₃ | HEMA | BNMA | SR541 | TS-720 | DIOXOLANE |
| COMPARATIVE | 0.028 | — | 0.043 | 0.953 | 0.953 | 0.953 | 0.143 | 0.814 |
| EXAMPLE | | | | | | | | |
| CE6-A Dark | | | | | | | | |
| COMPARATIVE | 0.028 | — | 0.009 | 0.953 | 0.953 | 0.953 | 0.143 | 0.843 |
| EXAMPLE | | | | | | | | |
| CE6-B Dark | | | | | | | | |
| COMPARATIVE | 0.028 | — | 0.004 | 0.953 | 0.953 | 0.953 | 0.143 | 0.844 |
| EXAMPLE | | | | | | | | |
| CE6-C Dark | | | | | | | | |
| E6-A Light | — | 0.045 | 0.043 | 0.953 | 0.953 | 0.953 | 0.143 | 0.793 |
| E6-B Light | — | 0.045 | 0.009 | 0.953 | 0.953 | 0.953 | 0.143 | 0.832 |
| E6-C Light | — | 0.045 | 0.004 | 0.953 | 0.953 | 0.953 | 0.143 | 0.834 |

Analyses of CE6-A Dark and E6-A Light were referenced (0% cure) to the methacrylate peak area of the first spectrum of the E6-A Light series. Analyses of CE6-B Dark and E6-B Light were referenced (0% cure) to the methacrylate peak area of the first spectrum of the E6-B Light series. Analyses of CE6-C Dark and E6-C Light were referenced (0% cure) to the methacrylate peak area of the first spectrum of the E6-C Light series.

Comparative Examples CE6-A Dark, CE6-B Dark and CE6-C Dark were analyzed for real-time curing according to the Test Method for Cure Monitoring by IR (Series). The Offset Times (time between mixing and the beginning of the series collection) were 2 minutes, 4 minutes, and 3 minutes, respectively.

Examples E6-A Light, E6-B Light and E6-C Light were analyzed for real-time curing according to the Test Method for Cure Monitoring by IR (Series). During the series, the specimens were irradiated according to the Test Method for Irradiation of Sandwich Specimens Inside the FTIR Spectrometer (irradiation time 5 sec). The time between the start of the series and the irradiation time was 30 min. The Offset Time (time between mixing and the beginning of the series collection) was 2 minutes for each specimen.

Each of the Example sandwiches in Table 22 was also monitored for curing by IR according to the Test Method for Cure Monitoring by IR (Individual Spectra). Final spectra were taken 1 day later. The results of this analysis (along with % cure numbers pulled from amidst the series) are compiled in Table 24, below.

TABLE 24

| | | % CURE | | | |
|---|---|---|---|---|---|
| | | AT 30 | TIME TO | % CURE 90 | % CURE |
| | INITIATOR | MINUTES | 90% CURE, | MINUTES | AFTER 1 |
| EXAMPLE | PACKAGE | (DARK) | MINUTES | AFTER UV | DAY |
| COMPARATIVE | 1:1 PhDMBA:Mn | 94.1% | 24.1 | N/A | 99.5% |
| EXAMPLE | | | | | |
| CE6-A Dark | | | | | |
| COMPARATIVE | 5:1 PhDMBA:Mn | 86.3% | 32.0 | N/A | 99.6% |
| EXAMPLE | | | | | |
| CE6-B Dark | | | | | |
| COMPARATIVE | 10:1 PhDMBA:Mn | 55.4% | 47.3 | N/A | 99.5% |
| EXAMPLE | | | | | |
| CE6-C Dark | | | | | |
| E6-A Light | 1:1 b-PhDMBA:Mn | 1.4% | N/A | 3.8% | 2.9% |
| E6-B Light | 5:1 b-PhDMBA:Mn | 1.6% | N/A | 13.5% | 40.9% |
| E6-C Light | 10:1 b-PhDMBA:Mn | 0.9% | N/A | 6.6% | 31.3% |

### Examples E7-A to E7-C

The loading of reducing agent in the formulations was 1.5 weight percent. The selected monomer composition was Resin 3. Dioxolane (to promote solubility of reagents) was also added. The mixtures in Table 25 were made in 20-mL glass vials, blended on a vortex mixer for 30 sec, and allowed to sit at room temperature.

TABLE 25

| STOCK | | | TREATMENT TO |
|---|---|---|---|
| MIXTURE | COMPONENT 1 | COMPONENT 2 | DISSOLVE |
| b-PhDMBA | 0.500 g, | 4.500 g, | Stirring at room |
| Stock 7 | b-PhDMBA | dioxolane | temperature |
| Mn | 0.500 g, | 4.500 g, | Stirring at room |
| Stock 7 | Mn(acac)₃ | dioxolane | temperature |

The stock mixtures were used to make mixtures that were loaded into IR sandwich specimens according to the Test Method for IR Specimen Sandwich Construction and are reported in Table 26, and in greater detail in Table 27, both below.

TABLE 26

| | MIXTURE | MIXTURE | MIXTURE | MIXTURE |
|---|---|---|---|---|
| EXAMPLE | COMPONENT 1 | COMPONENT 2 | COMPONENT 3 | COMPONENT 4 |
| E7-A | 450 mg, | 86 mg, | 3.000 g, | 0.285 g, |
| Light | b-PhDMBA Stock 7 | Mn Stock 7 | Resin 3 | dioxolane |
| E7-B | 450 mg, | 86 mg, | 3.000 g, | 0.285 g, |
| Light | b-PhDMBA Stock 7 | Mn Stock 7 | Resin 3 | dioxolane |
| E7-C | 450 mg, | 86 mg, | 3.000 g, | 0.285 g, |
| Light | b-PhDMBA Stock 7 | Mn Stock 7 | Resin 3 | dioxolane |

TABLE 27

| | GRAMS | | | | | | |
|---|---|---|---|---|---|---|---|
| EXAMPLE | b-PHDMBA | Mn(acac)₃ | HEMA | BNMA | SR541 | TS-720 | DIOXOLANE |
| E7-A Light | 0.045 | 0.009 | 0.953 | 0.953 | 0.953 | 0.143 | 0.767 |
| E7-B Light | 0.045 | 0.009 | 0.953 | 0.953 | 0.953 | 0.143 | 0.767 |
| E7-C Light | 0.045 | 0.009 | 0.953 | 0.953 | 0.953 | 0.143 | 0.767 |

Examples E7-A Light, E7-B Light and E7-C Light were analyzed for real-time curing according to the Test Method for Cure Monitoring by IR (Series). During the series, the specimens were irradiated according to the Test Method for Irradiation of Sandwich Specimens Inside the FTIR Spectrometer. The Offset Time (time between mixing and the beginning of the series collection) was 3 minutes for each specimen. The time between the beginning of the series and the irradiation time was 1 minute. Example E7-A Light was irradiated for 5 seconds. Example E7-B Light was irradiated for 15 seconds. Example E7-C Light was irradiated for 30 seconds. Each series analysis was referenced (0% cure) to the methacrylate peak area of the first spectrum in that series.

Each of the sandwiches in Table 26 was also monitored for curing by IR according to the Test Method for Cure Monitoring by IR (Individual Spectra). Final spectra were taken 1 day later. The results of this analysis (along with % cure numbers pulled from amidst the series) are compiled in Table 28, below.

TABLE 28

| | | UV | | |
|---|---|---|---|---|
| | | IRRADI- | % CURE 90 | % CURE |
| | INITIATOR | ATION | MINUTES | AFTER 1 |
| EXAMPLE | PACKAGE | TIME | AFTER UV | DAY |
| E7-A | 5:1 b- | 5 sec | 15.2 | 31.5 |
| Light | PhDMBA:Mn | | | |
| E7-B | 5:1 b- | 15 sec | 7.1 | 31.1 |
| Light | PhDMBA:Mn | | | |
| E7-C | 5:1 b- | 30 sec | 7.4 | 20.8 |
| Light | PhDMBA:Mn | | | |

### Examples E8-A to E8-C

The mixtures in Table 29 were made in 20-mL glass vials, blended on a vortex mixer for 30 sec, and allowed to sit at room temperature.

TABLE 29

| STOCK | | | TREATMENT |
|---|---|---|---|
| MIXTURE | COMPONENT 1 | COMPONENT 2 | TO DISSOLVE |
| Me-b- | 0.300 g, | 2.700 g, | Stirring at room |
| PhDMBA | Me-b-PhDMBA | dioxolane | temperature |
| Stock 8 | | | |
| Mn | 0.300 g, | 2.700 g, | Stirring at room |
| Stock 8 | Mn(acac)₃ | dioxolane | temperature |

The stock mixtures were used to make mixtures that were loaded into IR sandwich specimens according to the General Procedure for IR Specimen Sandwich Construction as reported in Table 30, and in greater detail in Table 31, both below.

TABLE 30

| | MIXTURE | MIXTURE | MIXTURE | MIXTURE |
|---|---|---|---|---|
| EXAMPLE | COMPONENT 1 | COMPONENT 2 | COMPONENT 3 | COMPONENT 4 |
| E8-A Dark | 466 mg, | 86 mg, | 3.000 g, | 0.271 g, |
| | Me-b-PhDMBA Stock 8 | Mn Stock 8 | Resin 3 | dioxolane |
| E8-B Light | 466 mg, | 86 mg, | 3.000 g, | 0.271 g, |
| | Me-b-PhDMBA Stock 8 | Mn Stock 8 | Resin 3 | dioxolane |
| E8-C Light | 466 mg, | 86 mg, | 3.000 g, | 0.271 g, |
| | Me-b-PhDMBA Stock 8 | Mn Stock 8 | Resin 3 | dioxolane |

TABLE 31

| | GRAMS | | | | | | |
|---|---|---|---|---|---|---|---|
| EXAMPLE | ME-b-PHDMBA | Mn(acac)₃ | HEMA | BNMA | SR541 | TS-720 | DIOXOLANE |
| E8-A Dark | 0.047 | 0.009 | 0.953 | 0.953 | 0.953 | 0.143 | 0.768 |
| E8-B Light | 0.047 | 0.009 | 0.953 | 0.953 | 0.953 | 0.143 | 0.768 |
| E8-C Light | 0.047 | 0.009 | 0.953 | 0.953 | 0.953 | 0.143 | 0.768 |

Examples E8-B Light and E8-C Light were analyzed for real-time curing according to the Test Method for Cure Monitoring by IR (Series). During the series, the specimens were irradiated according to the Test Method for Irradiation of Sandwich Specimens Inside the FTIR Spectrometer. The Offset Time (time between mixing and the beginning of the series collection) was 2 minutes for each specimen. The time between the beginning of the series and the irradiation time was 1 minute. Example E8-B Light was irradiated for 5 seconds. Example E8-C Light was irradiated for 15 seconds. Each series analysis was referenced (0% cure) to the methacrylate peak area of the first spectrum in that series.

Each of the sandwiches in Table 30 was also monitored for curing by IR according to the Test Method for Cure Monitoring by IR spectroscopy (Individual Spectra). Final spectra were taken 1 day later. The analysis of E8-A Dark was referenced (0% cure) to the methacrylate peak area of the first spectrum of the E8-B Light series. The results of this analysis (along with % cure numbers pulled from amidst the series) are compiled in Table 32, below.

TABLE 32

| | | | % CURE 90 | |
|---|---|---|---|---|
| | | UV | MIN AFTER | |
| | | IRRADI- | UV (OR | % CURE |
| | INITIATOR | ATION | MIXING | AFTER 1 |
| EXAMPLE | PACKAGE | TIME | FOR DARK) | DAY |
| E8-A | 5:1 Me-b- | None | −0.7%* | −4.6%* |
| Dark | PhDMBA:Mn | | | |
| E8-B | 5:1 Me-b- | 5 sec | 28.2% | 32.5% |
| Light | PhDMBA:Mn | | | |
| E8-C | 5:1 Me-b- | 15 sec | 19.0% | 31.8% |
| Light | PhDMBA:Mn | | | |

*In Table 32, a methacrylate peak area bigger than the original gives a “negative % cure” but was assumed to be 0% cure within the margin of error.

### Examples E9-A to E9-C and Comparative Example CE9-A

Both BuDMBA and b-BuDMBA were at least partially soluble in dioxolane and Resin 3. The loading of blocked reducing agent in the formulations was 1.5 weight percent, and the loading of unblocked reducing agent was chosen to match that molar amount. The selected monomer composition was Resin 3. Dioxolane was also added. The mixtures in Table 33 were made in 20-mL glass vials, blended on a vortex mixer for 30 sec, and allowed to sit at room temperature.

TABLE 33

| STOCK | | | TREATMENT |
|---|---|---|---|
| MIXTURE | COMPONENT 1 | COMPONENT 2 | TO DISSOLVE |
| BuDMBA | 0.300 g, | 2.700 g, | Stirring at room |
| Stock 9 | PhDMBA | dioxolane | temperature |
| b-BuDMBA | 0.300 g, | 2.700 g, | Stirring at room |
| Stock 9 | b-PhDMBA | dioxolane | temperature |
| Mn | 0.300 g, | 2.700 g, | Stirring at room |
| Stock 9 | Mn(acac)₃ | dioxolane | temperature |

The stock mixtures were used to make mixtures that were loaded into IR sandwich specimens according to the Test Method for IR Specimen Sandwich Construction and are reported in Table 34, and in greater detail in Table 35, both below.

TABLE 34

| | MIXTURE | | | |
|---|---|---|---|---|
| EXAMPLE | COMPONENT 1 | COMPONENT 2 | COMPONENT 3 | COMPONENT 4 |
| COMPARATIVE | 259 mg, | 86 mg, | 3.000 g, | 0.170 g |
| EXAMPLE | BuDMBA Stock 9 | Mn Stock 9 | Resin 3 | dioxolane |
| CE9-A Dark | | | | |
| E9-A Dark | 424 mg, | 86 mg, | 3.000 g, | — |
| | b-BuDMBA Stock 9 | Mn Stock 9 | Resin 3 | |
| E9-B Light | 424 mg, | 86 mg, | 3.000 g, | — |
| | b-BuDMBA Stock 9 | Mn Stock 9 | Resin 3 | |
| E9-C Light | 424 mg, | 86 mg, | 3.000 g, | — |
| | b-BuDMBA Stock 9 | Mn Stock 9 | Resin 3 | |

TABLE 35

| | Grams | | | | | | | |
|---|---|---|---|---|---|---|---|---|
| | | | | | | | TS- | |
| EXAMPLE | BuDMBA | b-BuDMBA | Mn(acac)₃ | HEMA | BnMA | SR541 | 720 | Dioxolane |
| COMPARATIVE | 0.026 | — | 0.009 | 0.953 | 0.953 | 0.953 | 0.143 | 0.480 |
| EXAMPLE | | | | | | | | |
| CE9-A Dark | | | | | | | | |
| E9-A Dark | — | 0.042 | 0.009 | 0.953 | 0.953 | 0.953 | 0.143 | 0.459 |
| E9-B Light | — | 0.042 | 0.009 | 0.953 | 0.953 | 0.953 | 0.143 | 0.459 |
| E9-C Light | — | 0.042 | 0.009 | 0.953 | 0.953 | 0.953 | 0.143 | 0.459 |

An initial IR spectrum of Example E9-A Dark was taken within 5 minutes after mixing. Examples E9-B Light, E9-C Light, and Comparative Example CE9-A Dark were analyzed for real-time curing according to the Test Method for Cure Monitoring by IR spectroscopy (Series). During the series, E9-B Light and E9-C Light were irradiated according to the Test Method for Irradiation of Sandwich Specimens Inside the FTIR Spectrometer. The Offset Time (time between mixing and the beginning of the series collection) was 1 minute for CE9-A Dark and E9-B Light, and 3 minutes for E9-C Light. The time between the beginning of the series and the irradiation time (for E9-B Light and E9-C Light) was 1 minute. Example E9-B Light was irradiated for 5 seconds. Example E9-C Light was irradiated for 15 seconds. The series analyses were referenced (0% cure) to the methacrylate peak area of the initial spectrum of E9-A Dark.

Each of the sandwiches was also monitored for curing by IR spectroscopy according to the Test Method for Cure Monitoring by IR spectroscopy (Individual Spectra). Final spectra were taken 1 day later. The results of this analysis (along with % cure numbers pulled from amidst the series) are compiled in Table 36, below.

TABLE 36

| | | | % CURE 30 | |
|---|---|---|---|---|
| | | | MIN AFTER | |
| | | UV | UV (OR | % CURE |
| | INITIATOR | IRRADIATION | MIXING FOR | AFTER 1 |
| EXAMPLE | PACKAGE | TIME | DARK) | DAY |
| COMPARATIVE | 5:1 BuDMBA:Mn | None | 98.0% | 99.5% |
| EXAMPLE | | | | |
| CE9-A Dark | | | | |
| E9-A Dark | 5:1 b-BuDMBA:Mn | None | — | 0.1% |
| E9-B Light | 5:1 b-BuDMBA:Mn | 5 sec | 6.8% | 2.8% |
| E9-C Light | 5:1 b-BuDMBA:Mn | 15 sec | 6.9% | 11.5% |

The preceding description, given in order to enable one of ordinary skill in the art to practice the claimed disclosure, is not to be construed as limiting the scope of the disclosure, which is defined by the claims and all equivalents thereto.

1. A free-radically polymerizable composition comprising:
at least one free-radically polymerizable compound;
at least one transition metal acetylacetonate coordination complex having a neutral charge; and
a photolabile reducing agent represented by the formula 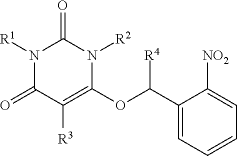
wherein R¹, R², and R³ are independently H or a C₁-C₁₈ hydrocarbyl group, and R⁴ is H or methyl.

2. The free-radically polymerizable composition of claim 1, wherein the polymerizable component comprises one or more (meth)acrylate compounds.

3. The free-radically polymerizable composition of claim 1, wherein the free-radically polymerizable composition is free of additional oxidizing agent.

4. The free-radically polymerizable composition of claim 1, wherein the at least one transition metal acetylacetonate coordination complex comprises at least one of manganese, copper, or vanadium.

5. The free-radically polymerizable composition of claim 4, wherein the transition metal acetylacetonate coordination complex comprises manganese.

6. The free-radically polymerizable composition of claim 1, wherein R⁴ is H.

7. The free-radically polymerizable composition of claim 1, wherein the at least one free-radically polymerizable compound comprises 5 to 30 weight percent of at least one compound having at least two (meth)acrylate groups.

8. The free-radically polymerizable composition of claim 1, wherein the transition metal acetylacetonate coordination complex comprises 0.05 to 1.5 parts by weight per 100 parts by weight of the at least one free-radically polymerizable compound.

9. The free-radically polymerizable composition of claim 1, wherein the photolabile reducing agent comprises about 0.5 to about 5 parts by weight per 100 parts by weight of the at least one free-radically polymerizable compound.

10. A method of polymerizing a free-radically polymerizable composition, the method comprising exposing a free-radically polymerizable composition according to claim 1 to actinic radiation effective to initiate free-radical polymerization and provide an at least partially polymerized composition.

11. An at least partially polymerized composition made according to the method of claim 10.
